(19) United States
(12) Patent Application Publication
(10) Pub. No.: US 2006/0136413 A1
(43) Pub. Date: Jun. 22, 2006

(54) Program

(75) Inventor: Takeaki Kato, Shizuoka-ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Chiyoda-ku (JP)

(21) Appl. No.: 11/015,456

(22) Filed: Dec. 16, 2004

(51) Int. Cl. G06F 17/30; G06F 7/00

(52) U.S. Cl. 707/6

(57) ABSTRACT

A CPU displays a watermark setting button on a display unit. When the watermark setting button is pressed, the CPU confirms whether there is mismatch between a character sequence and a font, which are selected in order to print a watermark, on the basis of a printer driver that is stored in a hard disk drive. If there is mismatch, the CPU switches the font to a system default font, and executes a watermark generation process.

### BACKGROUND OF THE INVENTION

1. Field of the Invention

The present invention relates to a program that avoids occurrence of garbage characters at a time of printing a watermark or a fax cover sheet.

2. Description of the Related Art

In a conventional printer driver, as regards print of a watermark, a garbage print result occurs regardless of the user's intention if an input character sequence or a character sequence, which is to be input, cannot be expressed with a selected font.

The input character sequence, or the character sequence that is to be input, is now referred to as “selection character sequence”, and the selected font is referred to as “selection font”.

An example of the case where a selection character sequence cannot be expressed with a selection font is that a 2-byte selection character sequence, “A, I, U, E, O” (Japanese characters), cannot be expressed with a 1-byte font such as “Times New Roman”. This is an obvious phenomenon since a 1-byte font includes no 2-type character information.

If a watermark is generated and printed while mismatch between the selection character sequence and the selection font is not corrected, the problem of occurrence of garbage characters will arise.

Besides, as regards a fax driver, if there is mismatch between a selection character sequence and a selection font, the problem of occurrence of garbage characters will arise in printing.

### BRIEF SUMMARY OF THE INVENTION

The object of an aspect of the present invention is to provide a program that enables printing by avoiding occurrence of a garbage character due to mismatching between a selection character sequence and a selection font.

According to an aspect of the present invention, there is provided a program that operates a printing apparatus in a system in which a personal computer and the printing apparatus are connected, the program comprising: confirming, when a print setting is instructed, whether there is mismatch between a selected character sequence and a selected font; switching, if there is mismatch, the font to a system default font; and executing a printing process using the switched system default font and the character sequence.

Additional objects and advantages of an aspect of the invention will be set forth in the description which follows, and in part will be obvious from the description, or may be learned by practice of the invention. The objects and advantages of an aspect of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate preferred embodiments of the invention, and together with the general description given above and the detailed description of the embodiments given below, serve to explain the principles of an aspect of the invention.

FIG. 1 is a block diagram that schematically shows the structure of a printing system according to the present invention;

FIG. 2 is a flow chart that illustrates the operation for avoiding garbage of a watermark;

FIG. 3 shows an example of screen display on a display unit when mismatch occurs;

FIG. 4 shows an example of screen display on the display unit when mismatch occurs;

FIG. 5 shows an example of screen display on the display unit when no mismatch occurs;

FIG. 6 is a flow chart that illustrates the operation for avoiding garbage on a fax cover sheet;

FIG. 7 shows an example of screen display on the display unit when mismatch occurs; and

FIG. 8 shows an example of screen display on the display unit when no mismatch occurs.

### DETAILED DESCRIPTION OF THE INVENTION

An embodiment of the present invention will now be described with reference to the accompanying drawings.

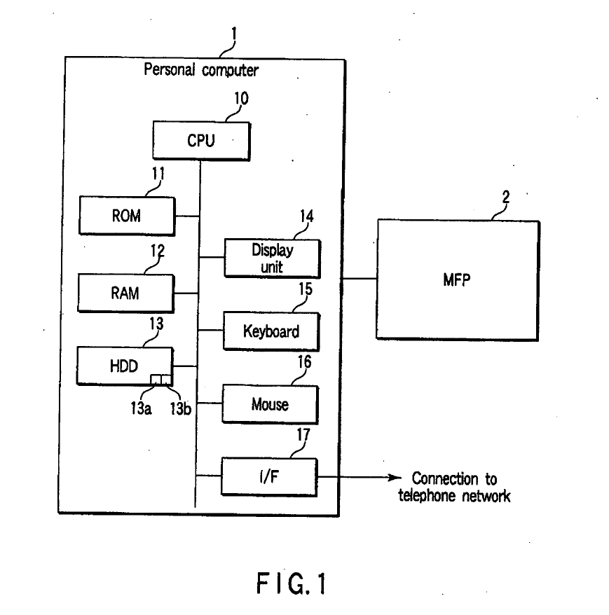

FIG. 1 schematically shows the structure of a printing system according to the present invention.

The printing system comprises a personal computer 1 and a digital multi-function peripheral (MFP) serving as printing means.

The personal computer 1 comprises a CPU 10 that executes an overall control, a ROM 11 that stores a control program, etc., a RAM 12 that stores data, a hard disk drive (HDD) 13, a display unit 14, a keyboard 15, a mouse 16, and an interface (I/F) 17 that is connected to a telephone network (not shown).

The HDD 13 stores a printer driver 13a and a fax driver 13b.

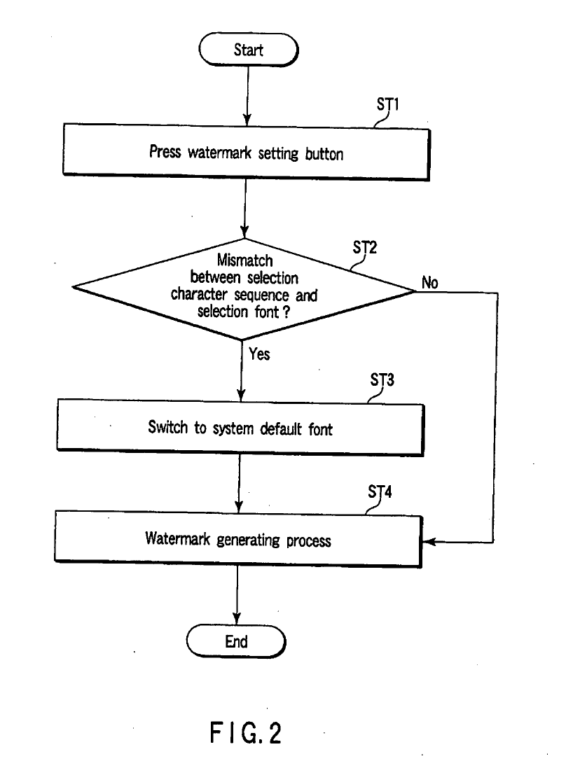

Next, referring to a flow chart of FIG. 2, a description is given of the operation for avoiding garbage of a watermark when the watermark is generated and printed in the above-described structure.

To start with, the CPU 10 displays a watermark setting button on the display unit 14.

When the watermark setting button is pressed by the user (ST1), the CPU 10 confirms whether there is mismatch between a selection character sequence and a selection font, on the basis of the printer driver 13a that is stored in the HDD 13 (ST2).

If there is mismatch, the CPU 10 switches the font to a system default font on the basis of the printer driver 13a (ST3).

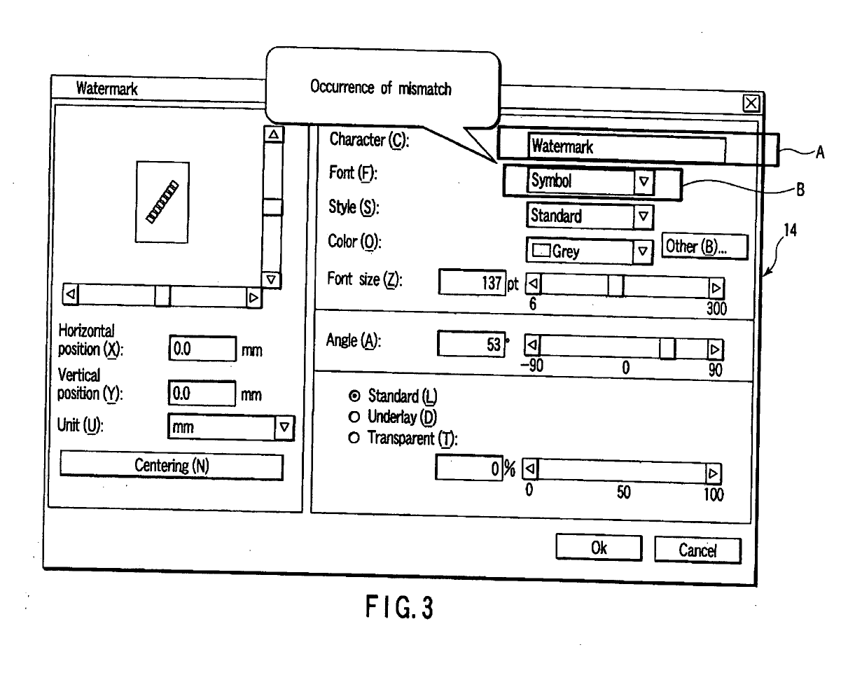

FIG. 3 shows an example of screen display on the display unit 14 when mismatch occurs. Specifically, when a selection character sequence A is “WATERMARK” (Japanese characters) and a selection font B is “Symbol”, mismatch is determined.

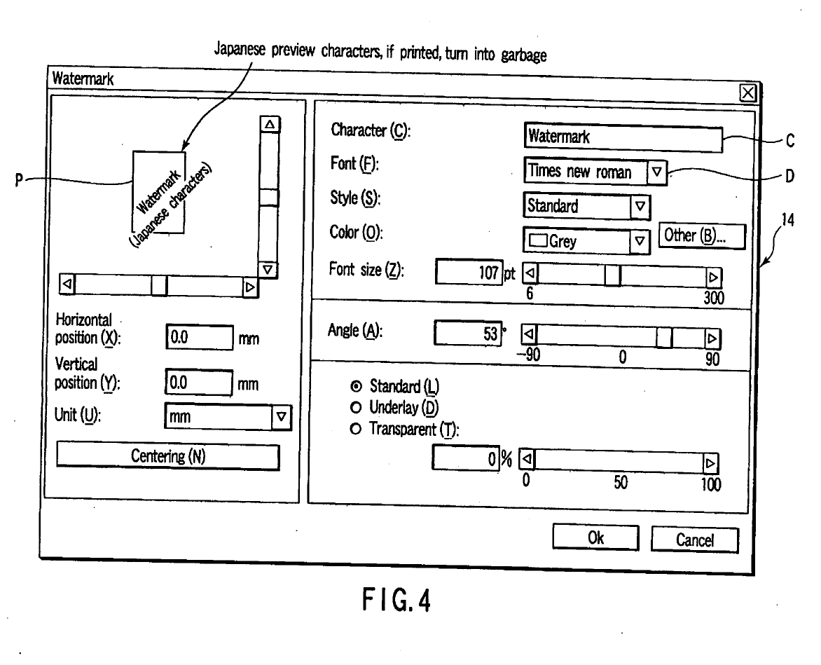

FIG. 4 also shows an example of screen display on the display unit 14 when mismatch occurs. Specifically, when a selection character sequence C is “WATERMARK” (Japanese characters) and a selection font D is “Times New Roman”, mismatch is determined. A preview screen P, which is provided on an upper left part of the display unit 14, displays “WATERMARK” (Japanese characters). These Japanese characters, when printed out, are turned into garbage characters.

When the font is switched to the system default font in step ST3, the CPU 10 executes a watermark generation process using the printer driver 13a (ST4).

If there is no mismatch in step ST2, the CPU 10 executes the watermark generation process using the printer driver 13a (ST4).

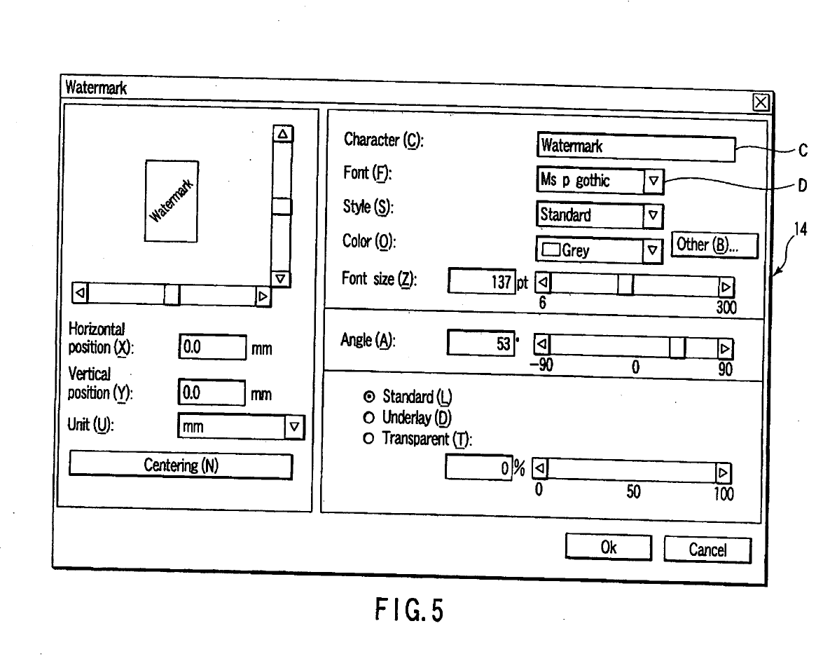

FIG. 5 shows an example of screen display on the display unit 14 when no mismatch occurs. Specifically, when a selection character sequence E is “WATERMARK” (English characters) and a selection font F is “MS P Gothic”, no mismatch is determined.

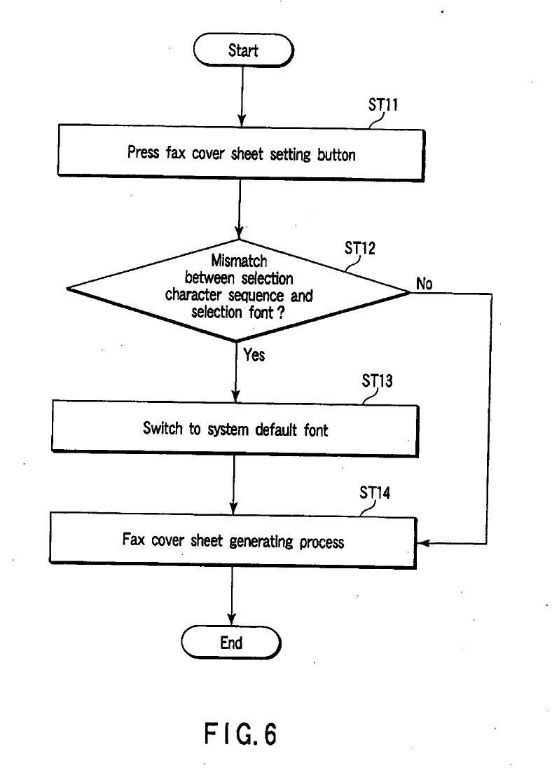

Next, referring to a flow chart of FIG. 6, a description is given of the operation for avoiding garbage on a fax cover sheet when fax print setting is executed.

To start with, the CPU 10 displays a fax cover sheet setting button on the display unit 14.

When the fax cover sheet setting button is pressed by the user (ST11), the CPU 10 confirms whether there is mismatch between a selection character sequence and a selection font, on the basis of the fax driver 13b that is stored in the HDD 13 (ST12).

If there is mismatch, the CPU 10 switches the font to a system default font on the basis of the fax driver 13b (ST13).

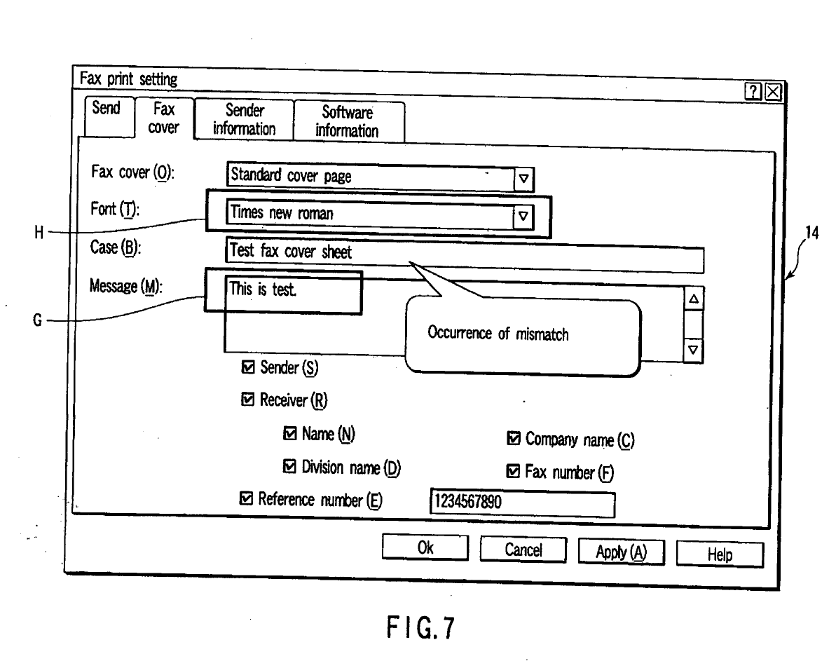

FIG. 7 shows an example of screen display on the display unit 14 when mismatch occurs. Specifically, when a selection character sequence G is “THIS IS TEST” (Japanese characters) and a selection font H is “Times New Roman”, mismatch is determined.

When the font is switched to the system default font in step ST13, the CPU 10 executes a fax cover sheet generation process using the fax driver 13b (ST14).

If there is no mismatch in step ST12, the CPU 10 executes the fax cover sheet generation process using the fax driver 13b (ST14).

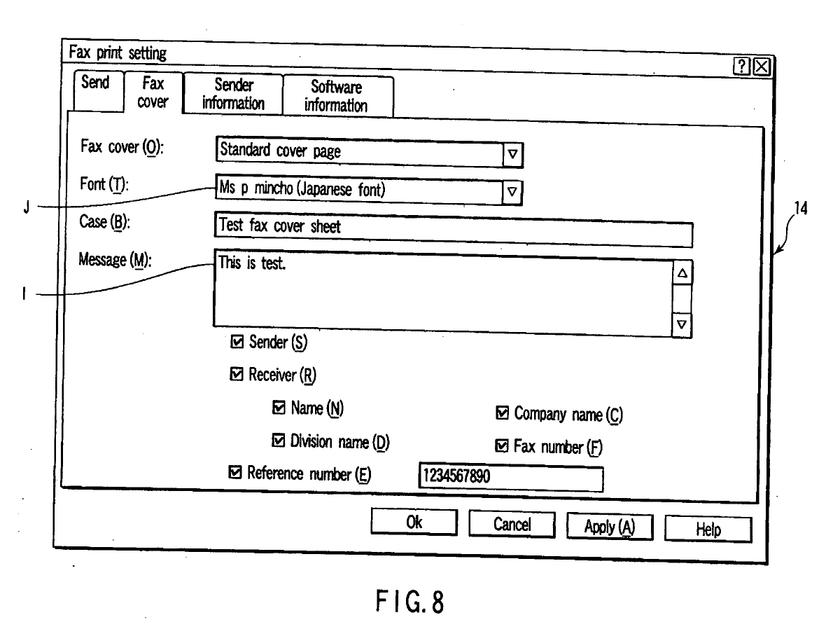

FIG. 8 shows an example of screen display on the display unit 14 when no mismatch occurs. Specifically, when a selection character sequence I is “THIS IS TEST” (Japanese characters) and a selection font J is “MS P Mincho” (Japanese font), no mismatch is determined.

As has been described above, according to the embodiment of the present invention, occurrence of garbage characters due to mismatch between a font and a character sequence is avoided in connection with a user's request for watermark printing, and a failure in print can be prevented.

In addition, a print error can be prevented without a redoing operation by the user.

Furthermore, since switching is effected to the default font of the operating system that is used by the user, garbage can be avoided in various environments.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A program that operates a printing apparatus in a system in which a personal computer and the printing apparatus are connected, the program comprising:
confirming, when a print setting is instructed, whether there is mismatch between a selected character sequence and a selected font;
switching, if there is mismatch, the font to a system default font; and
executing a printing process using the switched system default font and the character sequence.

2. A program that operates a printing apparatus in a system in which a personal computer and the printing apparatus are connected, the program comprising:
confirming, when a watermark setting is instructed, whether there is mismatch between a selected character sequence and a selected font;
switching, if there is mismatch, the font to a system default font; and
executing a watermark generating process using the switched system default font and the character sequence.

3. A program that operates a printing apparatus in a system in which a personal computer that is connected to a telephone network and the printing apparatus are connected, the program comprising:
confirming, when a fax cover sheet setting is instructed, whether there is mismatch between a selected character sequence and a selected font;
switching, if there is mismatch, the font to a system default font; and
executing a fax cover sheet generating process using the switched system default font and the character sequence.

4. A program that causes a personal computer, which operates a printing apparatus, to realize:
a confirming function of confirming, when a print setting is instructed, whether there is mismatch between a selected character sequence and a selected font;
a switching function of switching, if mismatch is confirmed by the confirming function, the font to a default font; and
a process function of causing the printing apparatus to execute a printing process using the default font, which is set by the switching function, and the character sequence.

5. A program that causes a personal computer, which operates a printing apparatus, to realize:
a confirming function of confirming, when a watermark setting is instructed, whether there is mismatch between a selected character sequence and a selected font;
a switching function of switching, if mismatch is determined by the confirming function, the font to a default font; and
a process function of executing a watermark generating process using the default font, which is set by the switching function, and the character sequence.

6. A program that causes a personal computer, which is connected to a telephone network and operates a printing apparatus, to realize:
a confirming function of confirming, when a fax cover sheet setting is instructed, whether there is mismatch between a selected character sequence and a selected font;
a switching function of switching, if mismatch is determined by the confirming function, the font to a default font; and
a process function of executing a fax cover sheet generating process using the default font, which is set by the switching function, and the character sequence.
